(19) United States
(12) Patent Application Publication
(10) Pub. No.: US 2015/0103190 A1
(43) Pub. Date: Apr. 16, 2015

(54) IMAGE ACQUISITION METHOD AND APPARATUS WITH MEMS OPTICAL IMAGE STABILIZATION (OIS)

(71) Applicant: DigitalOptics Corporation Europe Limited, Galway (IE)

(72) Inventors: Peter Corcoran, Claregalway (IE); Petrenol Bigioi, Galway (IE); Alexandru Drimbarean, Galway (IE); Adrian Zamfir, Bucuresti (RO); Corneliu Florean, Bucuresti (RO)

(21) Appl. No.: 14/516,030

(22) Filed: Oct. 16, 2014

Related U.S. Application Data
(60) Provisional application No. 61/891,417, filed on Oct. 16, 2013.

(51) Int. Cl. H04N 5/232; G02B 7/09

(52) U.S. Cl. CPC H04N 5/23267; H04N 5/23232; H04N 5/23258; H04N 5/23287; H04N 5/23212; H04N 5/23219; G02B 7/09
USPC 348/208.2; 348/357

(57) ABSTRACT

An image acquisition sensor of a digital image acquisition apparatus is coupled to imaging optics for acquiring a sequence of images. Images acquired by the sensor are stored. A motion detector causes the sensor to cease capture of an image when the degree of movement in acquiring the image exceeds a threshold. A controller selectively transfers acquired images for storage. A motion extractor determines motion parameters of a selected, stored image. An image re-constructor corrects the selected image with associated motion parameters. A selected plurality of images nominally of the same scene are merged and corrected by the image re-constructor to produce a high quality image of the scene.

### CROSS-REFERENCE TO RELATED APPLICATIONS

### Benefit Claim

This application claims the benefit of U.S. Provisional Application No. 61/891,417, filed Oct. 16, 2013, the entire contents of which is hereby incorporated by reference as if fully set forth herein, under 35 U.S.C. §119(e).

This application is related to U.S. Provisional Application No. 60/803,980, filed Jun. 5, 2006, and U.S. Provisional Application No. 60/892,880, filed Mar. 5, 2007, the entire contents of which is hereby incorporated by reference as if fully set forth herein.

### TECHNICAL FIELD

An image acquisition method and apparatus are provided, in particular, with improvements relating to compensating, preventing and/or correcting for acquisition device or subject movement during image acquisition.

### BACKGROUND

The approach to restoring an acquired image which is degraded or unclear either due to acquisition device or subject movement during image acquisition, divides in two categories:

Deconvolution where an image degradation kernel, for example, a point spread function (PSF) is known; and

Blind deconvolution where motion parameters are unknown.

Considering blind deconvolution (which is the most often case in real situations), there are two main approaches:

identifying motion parameters, such as PSF separately from the degraded image and using the motion parameters later with anyone of a number of image restoration processes; and

incorporating the identification procedure within the restoration process. This involves simultaneously estimating the motion parameters and the true image and it is usually done iteratively.

The first blind deconvolution approach is usually based on spectral analysis. Typically, this involves estimating the PSF directly from the spectrum or Cepstrum of the degraded image.

The Cepstrum of an image is defined as the inverse Fourier transform of the logarithm of the spectral power of the image. The PSF (point spread function) of an image may be determined from the Cepstrum, where the PSF is approximately linear. It is also possible to determine, with reasonable accuracy, the PSF of an image where the PSF is moderately curvilinear. This corresponds to even motion of a camera during exposure. It is known that a motion blur produces spikes in the Cepstrum of the degraded image.

So, for example, FIG. 5(a) shows an image of a scene comprising a white point on a black background which has been blurred to produce the PSF shown. (In this case, the image and the PSF are the same, however, it will be appreciated that for normal images this is not the case.) FIG. 5(b) shows the log of the spectrum of the image of FIG. 5(a), and this includes periodic spikes in values in the direction 44 of the PSF. The distance from the center of spectrum to the nearest large spike value is equal to the PSF size. FIG. 5(c) shows the Cepstrum of the image, where there is a spike 40 at the centre and a sequence of spikes 42. The distance between the IS center 40 and the first spike 42 is equal to the PSF length.

Techniques, for example, as described at M. Cannon “Blind Deconvolution of Spatially Invariant Image Blurs with Phase” published in IEEE Transactions on Acoustics, Speech, and Signal Processing, Vol. ASSP-24, NO. 1, February 1976 and refined by R. L. Lagendijk, 1. Biemond in “Iterative Identification and Restoration of Images”, Kluwer Academic Publishers, 1991 involve searching for those spikes in a Cepstrum, estimating the orientation and dimension of the PSF and, then, reconstructing the PSF from these parameters. This approach is fast and straight-forward, however, good results are usually generally achieved only for uniform and linear motion or for out of focus images. This is because for images subject to non-uniform or non-linear motion, the largest spikes are not always most relevant for determining motion parameters.

A second blind deconvolution approach involves iterative methods, convergence algorithms, and error minimization techniques. Usually, acceptable results are only obtained either by restricting the image to a known, parametric form (an object of known shape on a dark background as in the case of astronomy images) or by providing information about the degradation model. These methods usually suffer from convergence problems, numerical instability, and extremely high computation time and strong artifacts.

A CMOS image sensor may be built which can capture multiple images with short exposure times (SET images) as described in “A Wide Dynamic Range CMOS Image Sensor with Multiple Short-Time Exposures”, Sasaki et aI, IEEE Proceedings on Sensors, 2004, 24-27 Oct. 2004 Page(s):967-972 vol. 2.

Multiple blurred and/or undersampled images may be combined to yield a single higher quality image of larger resolution as described in “Restoration of a Single Superresolution Image from Several Blurred, Noisy and Undersampled Measured Images”, Elad et aI, IEEE Transactions on Image Processing, Vol. 6, No. 12, December 1997.

### BRIEF DESCRIPTION OF THE DRAWINGS

Embodiments will now be described by way of example, with reference to the accompanying drawings, in which:

FIG. 1 illustrates schematically a digital image acquisition apparatus according to an embodiment.

FIGS. 2(a)-2(b) illustrate (a) a PSF for a single image and (b) the PSFs for three corresponding SET images acquired according to the an embodiment.

FIGS. 3(a)-3(c) illustrate how blurring of partially exposed images can reduce the amount of motion blur in the image.

FIG. 4 illustrates the generation of a PSF for an image acquired in accordance with an embodiment;

FIGS. 5(a)-5(e) illustrate sample images/PSFs and their corresponding Cepstrums.

FIG. 6 illustrates an estimate of a PSF constructed according to an embodiment.

### DETAILED DESCRIPTIONS OF THE EMBODIMENTS

A digital image acquisition apparatus is provided. An image acquisition sensor is coupled to imaging optics for acquiring a sequence of images. An image store is for storing images acquired by the sensor. A motion detector is for causing the sensor to cease capture of an image when a degree of movement in acquiring the image exceeds a threshold. A controller selectively transfers the image acquired by the sensor to the image store. A motion extractor determines motion parameters of a selected image stored in the image store. An image reconstructor corrects a selected image with associated motion parameters. An image merger is for merging selected images nominally of the same scene and corrected by the image re-constructor to produce a high quality image of the scene.

The motion extractor may be configured to estimate a point spread function (PSF) for the selected image. The motion extractor may be configured to calculate a Cepstrum for the selected image, identify one or more spikes in the Cepstrum, and select one of the spikes in the Cepstrum as an end point for the PSF. The extractor may be configured to calculate a negative Cepstrum, and to set points in the negative Cepstrum having a value less than a threshold to zero.

In an alternative embodiment an active lens system, such as a MEMS lens, employs optical image stabilization (OIS) to dynamically correct for motion of the imaging device. An embodiment of such an OIS is described in US 20130077945 to Liu et al. In an embodiment of the present invention that incorporates an OIS there is no need to determine or estimate a PSF during image acquisition as the optical systems is adapted to eliminate the effects of device motion.

However there are practical limitations and for a MEMS based embodiment it can only compensate for motions up to 0.5-1 degree of angular movement from the original optical axis.

Thus, when this limit is reached image acquisition must be stopped, the MEMS lens is recentered and acquisition of a new image commences.

Returning to the original embodiment, the image store may include a temporary image store, and the apparatus may also include a non-volatile memory. The image merger may be configured to store the high quality image in the non-volatile memory.

The motion detector may include a gyro-sensor or an accelerometer, or both.

A further digital image acquisition apparatus is provided. An image acquisition sensor is coupled to imaging optics for acquiring a sequence of images. An image store is for storing images acquired by said sensor. A motion detector causes the sensor to cease capture of an image when the degree of movement in acquiring the image exceeds a first threshold. One or more controllers cause the sensor to restart capture when a degree of movement is less than a given second threshold, and selectively transfer images acquired by the sensor to the image store. A motion extractor determines motion parameters of a selected image stored in the image store.

An image re-constructor corrects a selected image with associated motion parameters. An image merger merges selected images nominally of the same scene and corrected by the image reconstructor to produce a high quality image of the scene.

In the alternative embodiment utilizing an OIS subsystem images are stored and merged in the same way. The only difference is that it is not necessary to reconstruct each component image using the extracted motion parameters as the OIS has already performed motion compensation on the component image. Thus in this embodiment it is not necessary to store motion data for each component image, neither is it necessary to re-construct these images as motion compensation has been performed during the acquisition phase. Thus the stored images are merged into a final high quality image in accordance with several advantageous embodiments.

A first exposure timer may store an aggregate exposure time of the sequence of images. The apparatus may be configured to acquire the sequence of images until the aggregate exposure time of at least a stored number of the sequence of images exceeds a predetermined exposure time for the high quality image. A second timer may store an exposure time for a single image. An image quality analyzer may analyze a single image. The apparatus may be configured to dispose of an image having a quality less than a given threshold quality and/or having an exposure time less than a threshold time.

The image merger may be configured to align the images prior to merging them. The first and second thresholds may include threshold amounts of motion energy.

An image capture method with motion elimination is also provided. An optimal exposure time is determined for the image. A sequence of consecutive exposures is performed, including:

(i) exposing intermediate images until either the optimal exposure time is reached or motion is detected beyond an excessive movement threshold; and

(ii) discarding images that have insufficient exposure times or that exhibit excessive movement;

(iii) storing non-discarded intermediate images for further image restoration, including:

(iv) performing motion de-blurring on non-discarded intermediate images;

(v) calculating a signal to noise ratio and, based on the calculating, performing exposure enhancement on the non-discarded images;

(vi) performing registration between restored intermediate images;

(vii) assigning a factor to each of the restored images based on quality of restoration, signal to noise ratio or overall exposure time, or combinations thereof; and

(viii) merging the restored images based on a weighted contribution as defined by said factor.

An aggregate exposure time of a sequence of images may be stored. The sequence of images may be acquired until the aggregate exposure time of at least a stored number of images exceeds a predetermined exposure time for a high quality image. An exposure time may be stored for a single image, and/or an image quality may be analyzed for a single image. An image may be disposed of that has an exposure time less than a threshold time and/or a quality less than a given threshold quality.

The merging may include aligning each restored image. A threshold may include a threshold amount of motion energy.

An image acquisition system is provided in accordance with an embodiment which incorporates a motion sensor and utilizes techniques to compensate for motion blur in an image.

One embodiment is a system that includes the following:

(1) the image acquisition apparatus comprises a imaging sensor, which could be CCD, CMOS, etc., hereinafter referred to as CMOS;
(2) a motion sensor (Gyroscopic, Accelerometer or a combination thereof);
(3) a fast memory cache (to store intermediate images); and
(4) a real-time subsystem for determining the motion (PSF) of an image. Such determination may be done in various ways. One preferred method is determining the PSF based on the image Cepstrum.

Alternatively component (4) may be replaced with an optical image stabilization system (OIS) that performs real-time adjustment of the device optics to compensate for device motion. Recent improvements in the motion sensing technology on modem handheld devices, together with fast-focusing lens technologies has enabled the replacement of (4) with such a real-time correction system.

In addition, the system can include a correction component, which may include:

(a) a subsystem for performing image restoration based on the motion PSF, (this subsystem can be replaced in certain embodiments by employing an OIS instead);
(b) an image merging subsystem to perform registration of multi-images and merging of images or part of images
(c) a CPU for directing the operations of these subsystems.

In certain embodiments some of these subsystems may be implemented in firmware and executed by the CPU. In alternative embodiments it may be advantageous to implement some, or indeed all of these subsystems as dedicated hardware units. Alternatively, the correction stage may be done in an external system to the acquisition system, such as a personal computer that the images are downloaded to.

In one embodiment, the Ceptrum may include the Fourier transform of the log-magnitude spectrum: fFt(ln(I fFt(window·signal)|)).

In a preferred embodiment the disclosed system is implemented on a dual-CPU image acquisition system where one of the CPUs is an ARM and the second is a dedicated DSP unit. The DSP unit has hardware subsystems to execute complex arithmetical and Fourier transform operations which provides computational advantages for the PSF extraction.

### Image Restoration and Image Merging Subsystems

In a preferred embodiment, when the acquisition subsystem is activated to capture an image it executes the following initialization steps: (i) the motion sensor and an associated rate detector are activated; (ii) the cache memory is set to point to the first image storage block; (iii) the other image processing subsystems are reset and (iv) the image sensor is signaled to begin an image acquisition cycle and (v) a count-down timer is initialized with the desired exposure time, a count-up timer is set to zero, and both are started.

In a given scene an exposure time is determined for optimal exposure. This will be the time provided to the main exposure timer. Another time period is the minimal-accepted-partially exposed image. When an image is underexposed (the integration of photons on the sensor is not complete) the signal to noise ratio is reduced. Depending on the specific device, the minimal accepted time is determined where sufficient data is available in the image without the introduction of too much noise. This value is empirical and relies on the specific configuration of the sensor acquisition system.

The CMOS sensor proceeds to acquire an image by integrating the light energy falling on each sensor pixel. If no motion is detected, this continues until either the main exposure timer counts down to zero, at which time a fully exposed image has been acquired. However, in this aforementioned embodiment, the rate detector can be triggered by the motion sensor. The rate detector is set to a predetermined threshold. One example of such threshold is one which indicates that the motion of the image acquisition subsystem is about to exceed the threshold of even curvilinear motion which will allow the PSF extractor to determine the PSF of an acquired image. The motion sensor and rate detector can be replaced by an accelerometer and detecting a +/− threshold level. The decision of what triggers the cease of exposure can be made on input form multiple sensor and/or a forumale trading of non-linear motion and exposure time.

In an alternative embodiment incorporating an OIS as described in US 20130077945 the threshold is an angular displacement of the MEMS lens from the main optical axis and this threshold will typically lie between 0.5 and 1.0 degrees of arc from the main axis, the exact angular threshold being dependent on the optical design and the configuration of the MEMS. The angular displacement will be known from look-up tables and the electrical conditions of the inputs to the MEMS actuators. In the MEMS OIS embodiment of US 20130077945 there are 3 actuators arranged in a triangular configuration.

When the rate detector is triggered then image acquisition by the sensor is halted. At the same time the count-down timer is halted and the value from the count-up timer is compared with a minimum threshold value. If this value is above the minimum threshold then a useful SET image was acquired and sensor read-out to memory cache is initiated. The current SET image data may be loaded into the first image storage location in the memory cache, and the value of the count-up timer (exposure time) is stored in association with the image. The sensor is then re-initialized for another short-time image acquisition cycle, the count-up timer is zeroed, both timers are restarted and a new image acquisition is initiated.

If the count-up timer value is below the minimum threshold then there was not sufficient time to acquire a valid short-time exposure and data read-out form the sensor is not initiated. The sensor is re-initialized for another short-time exposure, the value in the count-up timer is added to the count-down timer (thus restoring the time counted down during the acquisition cycle), the count-up timer is re-initialized, then both timers are restarted and a new image acquisition is initiated.

In the case of the MEMS OIS embodiment the MEMS lens must also be re-initialized that is re-centered on the main optical axis. This is achieved very quickly for a MEMS, typically in 1-2 ms and so there is not a significant delay and the operation of this embodiment is very similar to the original embodiment.

This process repeats itself until in total the exposure exceeds the needed optimal integration time. If for example in the second SET image reaches full term of exposure, it will then become the final candidate, with no need to perform post processing integration. If however, no single image exceeds the optimal exposure time, an integration is performed. This cycle of acquiring another short-time image continues until the count-down timer reaches zero-in a practical embodiment the timer will actually go below zero because the last short-time image which is acquired must also have an exposure time greater than the minimum threshold for the count-up timer. At this point there should be N short-time images captured and stored in the memory cache. Each of these short-time images will have been captured with an curvilinear motion-PSF. The total sum of N may exceed the optimal exposure time, which in this case the “merging system will have more images or more data to choose from overall.

In the case of an embodiment where a MEMS OIS is employed it is not necessary to store the motion-PSF information as SET images can be substantially corrected for device motion.

After a sufficient exposure is acquired it is now possible in a preferred embodiment to recombine the separate short-term exposure images as follows:

(i) each image is processed by a PSF extractor which can determine the linear or curvilinear form of the PSF which blurred the image; (this step may be omitted in certain embodiments for a MEMS OIS embodiment);

(ii) the image is next passed onto an image re-constructor which also takes the extracted PSF as an input; this reconstructs each short-time image in turn. Depending on the total exposure time, this image may also go through exposure enhancement which will increase its overall contribution to the final image. Of course, the decision whether to boost up the exposure is a tradeoff between the added exposure and the potential introduction of more noise into the system. The decision is performed based on the nature of the image data (highlight, shadows, original exposure time) as well as the available SET of images altogether. In a pathological example if only a single image is available that only had 50% exposure time, it will need to be enhanced to 2× exposure even at the risk of having some noise. If however, two images exist each with 50% exposure time, and the restoration is considered well, no exposure will be needed. Finally, the motion-corrected and exposure corrected images are passed it onto; and

(iii) the image merger; the image merger performs local and global alignment of each short-term image using techniques which are well-known to those skilled in the arts of super-resolution and advanced image processing; these techniques allow each short-time image to contribute to the construction of a higher resolution main image.

This approach has several advantages including:

(1) the number of SET is kept to a minimum; if the motion throughout an exposure is constant linear or curvilinear motion then only a single image need be captured;
(2) the decision of who at images are used to create the Final image are determined post processing thus enabling more flexibility in determining the best combination, where the motion throughout an exposure is mostly regular, but some rapid deviations appear in the middle the invention will effectively “skip over” these rapid deviations and a useful image can still be obtained; this would not be possible with a conventional image acquisition system which employed super-resolution techniques because the SET images are captured for a fixed time interval;
(3) where the image captured is of a time frame that is too small, this portion can be discarded;

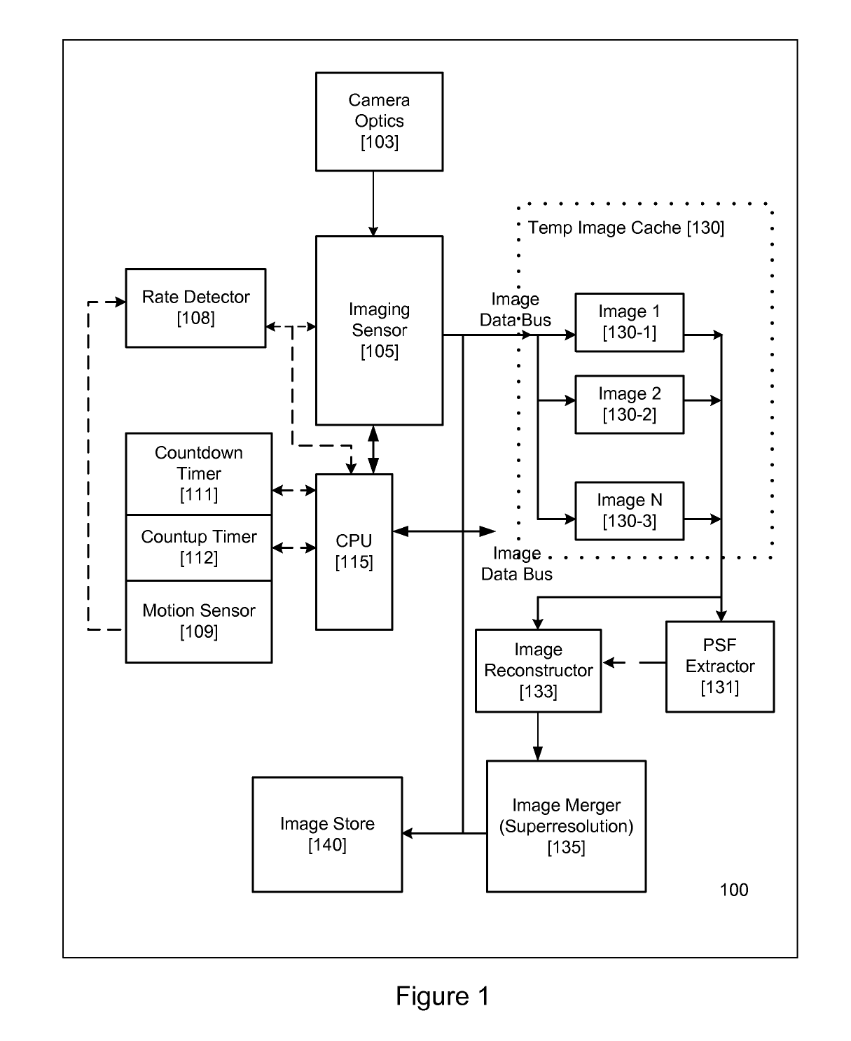

Referring now to FIG. 1, which illustrates a digital image acquisition apparatus 100 according to a preferred embodiment of the present invention, the apparatus 100 comprises a CMOS imaging sensor 105 coupled to camera optics 103 for acquiring an image.

The apparatus includes a CPU 115 for controlling the sensor 105 and the operations of sub-systems within the apparatus. Connected to the CPU 115 are a motion sensor 109 and an image cache 130. Suitable motion sensors include a gyroscopic sensor (or a pair of gyro sensors) that measures the angular velocity of the camera around a given axis, for example, as produced by Analog Devices' under the part number ADXRS401.

In FIG. 1, a subsystem 131 for estimating the motion parameters of an acquired image and a subsystem 133 for performing image restoration based on the motion parameters for the image are shown coupled to the image cache 130. In the embodiment, the motion parameters provided by the extractor sub-system 131 comprise an estimated PSF calculated by the extractor 131 from the image Cepstrum.

An image merging subsystem 135 connects to the output of the image restoration subsystem 133 to produce a single image from a sequence of one or more de-blurred images.

In certain embodiments some of these subsystems of the apparatus 100 may be implemented in firmware and executed by the CPU; whereas in alternative embodiments it may be advantageous to implement some, or indeed all of these subsystems as dedicated hardware units.

So for example, in a preferred embodiment, the apparatus 100 is implemented on a dual-CPU system where one of the CPUs is an ARM Core and the second is a dedicated DSP unit. The DSP unit has hardware subsystems to execute complex arithmetical and Fourier transform operations, which provides computational advantages for the PSF extraction 131, image restoration 133 and image merging 135 subsystems.

When the apparatus 100 is activated to capture an image, it firstly executes the following initialization steps:

(i) the motion sensor 109 and an associated rate detector 108 are activated;

(ii) the cache memory 130 is set to point to a first image storage block 130-1;

(iii) the other image processing subsystems are reset;

(iv) the image sensor 105 is signaled to begin an image acquisition cycle; and

(v) a count-down timer 111 is initialized with the desired exposure time, a count-up timer 112 is set to zero, and both are started.

The CMOS sensor 105 proceeds to acquire an image by integrating the light energy falling on each sensor pixel; this continues until either the main exposure timer counts 111 down to zero, at which time a fully exposed image has been acquired, or until the rate detector 108 is triggered by the motion sensor 109. The rate detector is set to a predetermined threshold which indicates that the motion of the image acquisition subsystem is about to exceed the threshold of even curvilinear motion which would prevent the PSF extractor 131 accurately estimating the PSF of an acquired image.

In alternative implementations, the motion sensor 109 and rate detector 108 can be replaced by an accelerometer (not shown) and detecting a +/− threshold level. Indeed any suitable subsystem for determining a degree of motion energy and comparing this with a threshold of motion energy could be used.

In an alternative embodiment incorporating an OIS as described in US 20130077945 the threshold is an angular displacement of the MEMS lens from the main optical axis and this threshold will typically lie between 0.5 and 1.0 degrees of arc from the main axis, the angular threshold being dependent on the optical design and the configuration of the MEMS. The angular displacement may be determined from look-up tables and the electrical conditions of the inputs to the MEMS actuators. In the MEMS OIS embodiment of US 20130077945 there are 3 actuators arranged in a triangular configuration.

When the rate detector 108 is triggered, then image acquisition by the sensor 105 is halted; at the same time the count-down timer 111 is halted and the value from the count-up timer 112 is compared with a minimum threshold value. If this value is above the minimum threshold then a useful short exposure time (SET) image was acquired and sensor 105 read-out to memory cache 130 is initiated; the current SET image data is loaded into the first image storage location in the memory cache, and the value of the count-up timer (exposure time) is stored in association with the SET image.

The sensor 105 is then re-initialized for another SET image acquisition cycle, the count-up timer is zeroed, both timers are restarted and a new image acquisition is initiated.

For the MEMS OIS the re-initialization step includes in certain embodiments a realignment of the MEMS lens with the main optical axis. This is achieved by zeroing the inputs to the MEMS actuators (i.e. applying suitable offset voltages to the actuators to achieve an ‘initial’ or ‘zero’ condition of the OIS). As MEMS response times are fast—typically of a couple of milliseconds—this process is in certain embodiments faster than a process involving re-initialization of the sensor.

If the count-up timer 112 value is below the minimum threshold, then there was not sufficient time to acquire a valid SET image and data read-out from the sensor is not initiated.

The sensor is re-initialized for another short exposure time, the value in the count-up timer 112 is added to the count-down timer 111 (thus restoring the time counted down during the acquisition cycle), the count-up timer is re-initialized, then both timers are restarted and a new image acquisition is initiated.

This cycle of acquiring another SET image 130-n continues until the count-down timer 111 reaches zero. Practically, the timer will actually go below zero because the last SET image which is acquired must also have an exposure time greater than the minimum threshold for the count-up timer 112. At this point, there should be N short-time images captured and stored in the memory cache 130. Each of these SET images will have been captured with a linear or curvilinear motion-PSF.

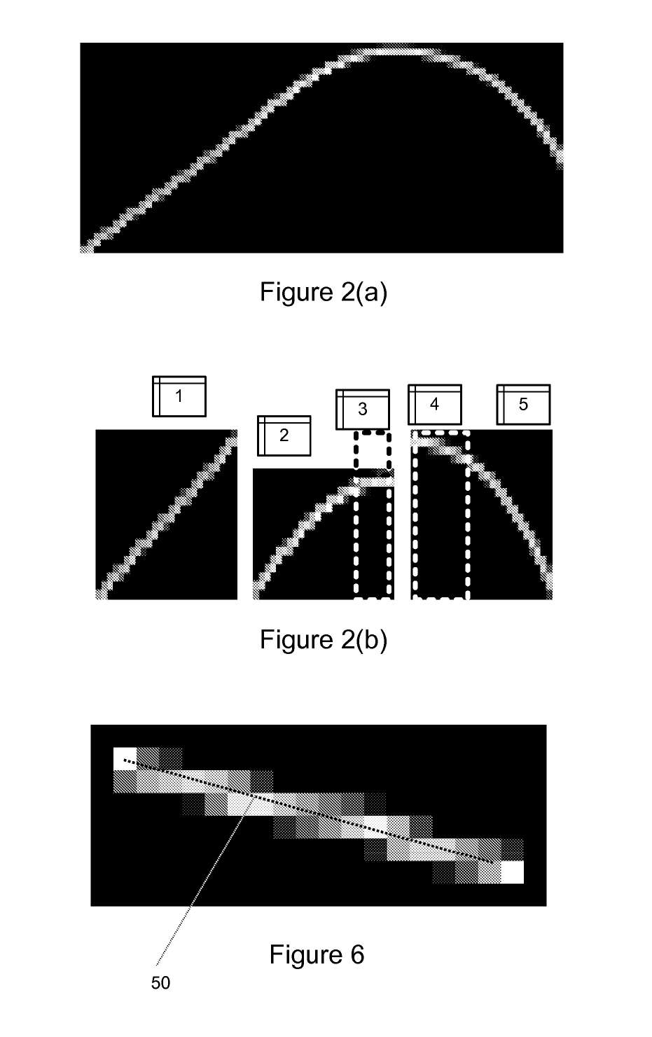

FIGS. 2a-2b illustrates Point Spread Functions (PSF). FIG. 2(a) shows the PSF of a full image exposure interval; and FIG. 2(b) shows how this is split into five SET-exposures by the motion sensor. In FIG. 2, boxes (1) through (5) are shown, and:

(1) will be used and with the nature of the PSF it has high probability of good restoration and also potential enhancement using gain;

(2) can be well restored;

(3) will be discarded as too short of an integration period;

(4) will be discarded having a non-curvilinear motion; and

(5) can be used for the final image.

So for example, while a single image captured with a full-exposure interval might have a PSF as shown in FIG. 2(a), a sequence of 3 images captured according to the above embodiment, might have respective PSFs as shown in FIG. 2(b). It will be seen that the motion for each of these SET image PSFs more readily lends the associated images to de-blurring than the more complete motion of FIG. 2(a).

After a sufficient exposure is acquired, it is now possible to recombine the separate SET images 130-1 to 130-N as follows:

(i) each image is processed by the PSF extractor 131 which estimates the PSF which blurred the SET image;

(ii) the image is next passed onto the image re-constructor 133 which as well as each SET image takes the corresponding estimated PSF as an input; this reconstructs each SET image in turn and passes it onto the image merger 135;

(iii) the image merger 135 performs local and global alignment of each SET image using techniques which are well-known to those skilled in the art of super-resolution. These techniques allow each de-blurred SET image to contribute to the construction of a higher resolution main image which is then stored in image store 140. The image merger may during merging decide to discard an image where it is decided it is detrimental to the final quality of the merged image; or alternatively various images involved in the merging process can be weighted according to their respective clarity.

This approach has several benefits over the prior art:

(i) the number of SET images is kept to a minimum; if the motion throughout an exposure is constant linear or curvilinear motion then only a single image needs to be captured;

(ii) where the motion throughout an exposure is mostly regular, but some rapid deviations appear in the middle, the embodiment will effectively “skip over” these rapid deviations and a useful image can still be obtained. This would not be possible with a conventional image acquisition system which employed super-resolution techniques, because the SET images are captured for a fixed time interval.

Although the embodiment above could be implemented with a PSF extractor 131 based on conventional techniques mentioned in the introduction, where a PSF involves slightly curved or non-uniform motion, the largest spikes may not always be most relevant for determining motion parameters, and so conventional approaches for deriving the PSF even of SET images such as shown in FIG. 2(b) may not provide satisfactory results.

Thus, in a particular implementation of the present invention, the PSF extractor 131 rather than seeking spikes in a Cepstrum, seeks large regions around spikes in the Cepstrum of an image using a region-growing algorithm. This is performed by inspecting candidate spikes in the Cepstrum, using region growing around these candidates and then discriminating between them. Preferably, the candidate spike of the largest region surrounding a candidate spike will be the point chosen as the last point of the PSF.

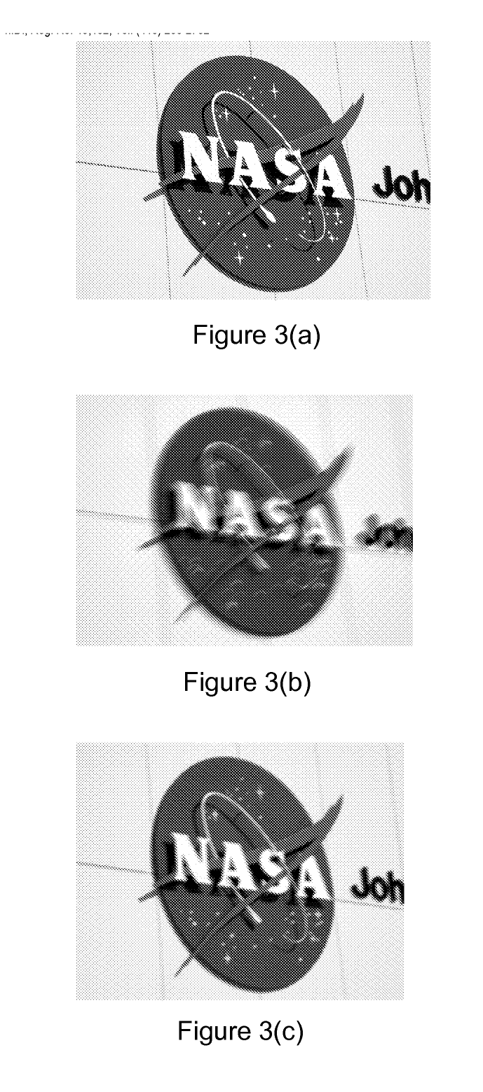

It can be seen from FIGS. 3(a)-3(c) that blurring the partially exposed image reduces the amount of motion blur in the image. FIG. 3(a) shows an original image. FIG. 3(b) illustrates blurring with full PSF. FIG. 3(c) illustrates reconstructed image from 3 SET images using individual PSFs.

Referring to FIG. 3, an SET image 130-1 . . . 130-N is represented in the RGB space (multi-channel) or as a gray-scale (“one-channel”). The Cepstrum may be computed on each color channel (in the case of multi-channel image) or only on one of them and so, by default, the Cepstrum would have the size of the degraded image. In the preferred embodiment, the Fourier transform is performed, step 32 only on the green channel. It will also be seen that, for processing simplicity, the results are negated to provide a negative Cepstrum for later processing.

In variations of the embodiment, the Cepstrum may be computed:

on each channel and, afterwards, averaged; or

on the equivalent gray image.

After computing the negative Cepstrum, the blurred image 130 is not necessary for the extractor 131 and can be released from memory or for other processes. It should also be seen that as the Cepstrum is symmetrical towards its center (the continuous component), only one half is required for further processing.

As discussed in the introduction, images which are degraded by very large movements are difficult to restore. Experiments have shown that if the true PSF is known, a restored image can have an acceptable quality where the PSF is smaller than 10% of the image size. The preferred embodiment ideally only operates on images subject to minimal movement. Thus, the original image can either be sub-sampled, preferably to ⅓ of its original size or once the Cepstrum is computed, it can be sub-sampled before further processing or indeed during further processing without having a detrimental effect on the accuracy of the estimated PSF where movement is not too severe. This can also be considered valid as the blurring operation may be seen as a low-pass filtering of an image (the PSF is indeed a low pass filter); and therefore there is little benefit in looking for PSF information in the high frequency domain.

The next step 34 involves thresholding the negative Cepstrum. This assumes that only points in the negative Cepstrum with intensities higher than a threshold (a certain percent of the largest spike) are kept. All the other values are set to zero. This step has, also, the effect of reducing noise. The value of the threshold was experimentally set to 9% of the largest spike value.

Pixel candidates are then sorted with the largest spike (excluding the Cepstrum center) presented first as input to a region-growing step 36, then the second spike and so on.

The region-growing step 36 has as main input a sequence of candidate pixels (referred to by location) as well as the Cepstrum and it returns as output the number of pixels in a region around each candidate pixel. Alternatively, it could return the identities of all pixels in a region for counting in another step, although this is not necessary in the present embodiment. A region is defined as a set of points with similar Cepstrum image values to the candidate pixel value. In more detail, the region-growing step 36 operates as follows:

1. Set the candidate pixel as a current pixel.

2. Inspect the neighbors of the current pixel-up to 8 neighboring pixels may not already be counted in the region for the candidate pixel or other regions. If the neighboring pixel meets an acceptance condition, preferably that its value is larger than 0.9 of the value of the candidate pixel value, then include it in the region for the candidate pixel, exclude the pixel from further regions, and increment the region size.

3. If a maximum number of pixels, say 128, has been reached, exit

4. After finished inspecting neighbors for the current pixel, if there are still un-investigated pixels, set the first included pixel as the current pixel and jump to step 2.

5. If there are no more un-investigated adjacent pixels, exit.

As can be seen, each pixel may be included in only one region. If the region-growing step 36 is applied to several candidate pixels, then a point previously included in a region will be skipped when investigating the next regions.

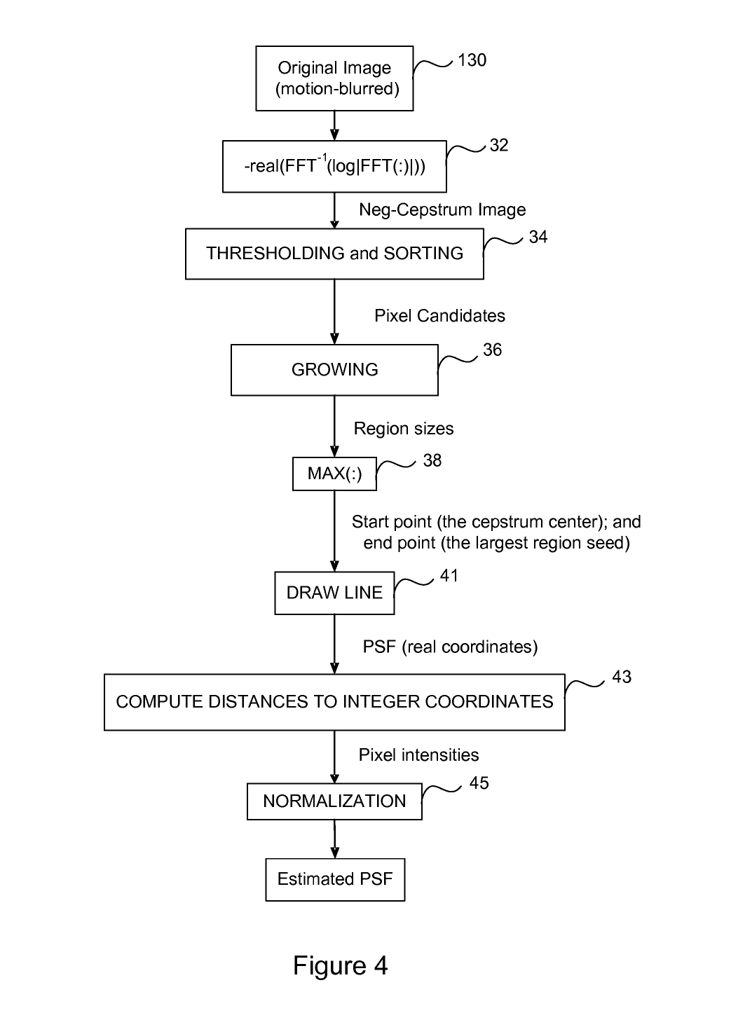

After comparison of the sizes of all grown regions, step 38, the pixel chosen is the candidate pixel for the region with the greatest number of pixels and this selected point is referred to as the PSF “end point”. The PSF “start point” is chosen the center of the Cepstrum, point 40 in FIG. 4(b)(ii).

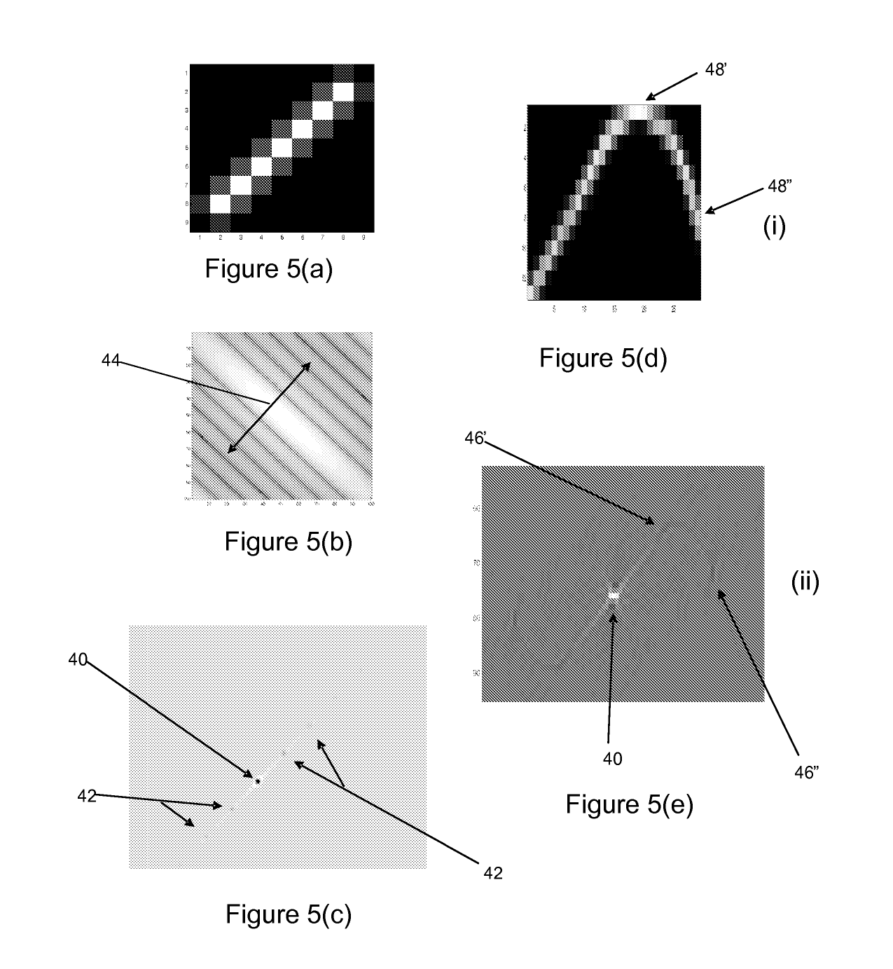

Referring to FIG. 5(d), where the negative Cepstrum has been obtained from an image, FIG. 5(e) degraded with a non-linear PSF, there are areas 46′, 46″ with spikes (rather than a single spike) which correspond to PSF turning points 48′, 48″, and it is areas such as these in normal images which the present implementation attempts to identify in estimating the PSF for an SET image.

In a continuous space, the estimated PSF would be a straight-line segment, such as the line 50 linking PSF start and end points, as illustrated at FIG. 6. In the present embodiment, the straight line is approximated in the discrete space of the digital image, by pixels adjacent the straight-line 50 linking the PSF start and end points, as illustrated at FIG. 6. Thus, all the pixels adjacent the line 50 connecting the PSF start and end points are selected as being part of the estimated PSF, step 41. For each PSF pixel, intensity is computed by inverse proportionality with the distance from its center to the line 50, step 43. After the intensities of all pixels of the PSF are computed, a normalization of these values is performed such that the sum of all non-zero pixels of the PSF equals 1, step 45.

Using the approach above, it has been shown that if the type of movement in acquiring the component SET images of an image is linear or near linear, then the estimated PSF produced by the extractor 131 as described above provides good estimate of the actual PSF for deblurring.

As the curving of movement increases, during restoration, ringing proportional to the degree of curving is introduced. Similarly, if motion is linear but not uniform, restoration introduces ringing which is proportional with the degree of non-uniformity. The acceptable degree of ringing can be used to tune the motion sensor 108 and rate detector 109 to produce the required quality of restored image for the least number of SET images.

Also, if this PSF extractor 131 is applied to images which have been acquired with more than linear movement, for example, night pictures having a long exposure time, although not useful for deblurring, the estimated PSF provided by the extractor 131 can provide a good start in the determination of the true PSF by an iterative parametric blind deconvolution process (not shown) for example based on Maximum Likelihood Estimation, as it is known that the results of such processes fade if a wrong starting point is chosen.

As remarked previously, when a MEMS-OIS embodiment is available the process of determining a PSF and correction of individual SET images becomes redundant. However some embodiments may retain the PSF components to provide a hybrid embodiment. The advantage here is that the OIS can compensate accurately for small-oscillation movements such as handshake, but where there is an intentional regular motion (such as a panning of the camera), or large-oscillation movements (such as the user running or cycling which capturing a video) then the OIS can be replaced with PSF determination and correction based on the determined PSF, particularly when the OIS technique would lead to too frequent acquisitions of SET images. In such cases it may be advisable to combine OIS with PSF techniques so that OIS corrects for small movements, but PSF is actuated when OIS first exceeds its threshold and used with a second, higher tolerance for motion. Thus some images that exhibit linear or pseudo-linear motion that is larger than can be handled by OIS will be corrected by PSF, whereas images below the OIS threshold will be handled by the OIS rather than PSF reconstruction. After the reconstruction stage both OIS and PSF-reconstructed images can be merged together by the image merger. Thus the benefits of handling larger oscillation motions and even panning effect could be provided by such a hybrid imaging system.

The above embodiments have been described in terms of a CMOS imaging sensor 105. In alternative implementations, a CCD image sensor or indeed any another suitable image sensor could be used. For a CCD, which is typically used with a shutter and which might normally not be considered suitable for providing the fine level of control required by the present invention, progressive readout of an image being acquired should be employed rather than opening and closing the shutter for each SET image.

The present invention is not limited to the embodiments described above herein, which may be amended or modified without departing from the scope of the present invention as set forth in the appended claims, and structural and functional equivalents thereof.

In methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

In addition, all references cited above herein, in addition to the background and summary of the invention sections, as well as US published patent application nos. 2006/0204110, 2006/0098890, 2005/0068446, 2006/0039690, and 2006/0285754, and U.S. patent application Nos. 601773,714, 60/803,980, and 60/821,956, which are to be or are assigned to the same assignee, are all hereby incorporated by reference into the detailed description of the preferred embodiments as disclosing alternative embodiments and components.

In addition, the following United States published patent applications are hereby incorporated by reference for all purposes including into the detailed description as disclosing alternative embodiments:

US 2005/0219391—Luminance correction using two or more captured images of same scene.

US 2005/0201637—Composite image with motion estimation from multiple images in a video sequence.

US 2005/0057687—Adjusting spatial or temporal resolution of an image by using a space or time sequence (claims are quite broad)

US 2005/0047672—Ben-Ezra patent application; mainly useful for supporting art; uses a hybrid imaging system with fast and slow detectors (fast detector used to measure PSF).

US 2005/0019000—Supporting art on super-resolution.

US 2006/0098237—Method and Apparatus for Initiating Subsequent Exposures Based on a Determination of Motion Blurring Artifacts (and 2006/0098890 and 2006/0098891).

The following provisional application is also incorporated by reference: serial no. 601773,714, filed Feb. 14, 2006, entitled Image Blurring.

### Re-Focus within a Single Image Frame

The speed of MEMs not only enables re-focus from frame to frame, but also allows refocusing within a single frame in certain embodiments. Blur or distortion to pixels due to relatively small movements of the focus lens are manageable within digital images. Micro-adjustments to AF are included in certain embodiments within the same image frame serving, e.g., to optimize local focus on multiple regions of interest. In this embodiment, pixels may be clocked row-by-row from the sensor and sensor pixels may correspond 1-to-1 with image frame pixels. Inversion and de-Bayer operations are applied in certain embodiments.

In certain embodiments, lines of pixels flow to an Image Signal Processor (ISP) after they are clocked from the sensor in sequence. Pixels are clocked out row-by-row from the top down and from left to right across each row. As an example, assume an image has four different face regions where, from the top row, pixels to the left of the first predicted face region (f1) are ‘clear’, whereas pixels to the right of the first pixel of this ROI are blue/dark. Lens motion is ceased during the exposure interval of these ‘dark’ pixels to avoid lens-motion blur/distortion. The lens remains still while all intermediate rows of the sensor down to the last pixel of the second face region (f2) are exposed in this example. However, once the last data pixel of 12 is clocked to the ISP, the lens could begin to move again, although the lens motion would be ceased again to allow the first pixel of the third face region (f3) time to complete exposure. Thus if the time for two exposure intervals is longer than the time gap to offload data from 12 to f3, there will not be sufficient time for lens motion between f2 and f3. The physical overlap of rows f1 and 12, and also f3 and f4, in the present example does not allow any lens motion between these ROIs. Re-focus within a frame may be provided in certain embodiments when the exposure time of individual pixels is quite short compared with the full image acquisition cycle (e.g., 33 ms).

### Alternating Focus Techniques

In another advantageous embodiment, focus is switched between face regions for alternating image acquisitions. In an example of this embodiment, the lens may be moved to an intermediate position that lies approximately midway to the four focus settings, f1, f2, f3, and f4. Then, on each successive image frame the focus is moved to the optimal focus for each face region. This cycle is continued on subsequent image acquisitions.

The resulting image stream has a sharp focus on one of the four face regions in successive image frames while other regions of the image are less sharply focused. US published patent application nos. 201110205381, 2008/0219581, 2009/0167893, and 2009/0303343 describe techniques to combine one or more sharp, underexposed images with one or more blurred, but normally exposed images to generate an improved composite image. In this case, there is one sharply focused image of each face or other ROI and three more or less slightly defocused images of the face or other ROI. In certain embodiments, an improved video is generated from the perspective of each face or other ROI, i.e., with each face image in optimal focus throughout the video. One of the other persons can change the configuration to create an alternative video where the focus is on them instead.

In another embodiment, a similar effect is obtained by using two cameras including one that is focused on the subject and one that is focused on the background. In fact, with a dual camera in accordance with this embodiment, different focus points are very interesting tools for obtaining professional depth 2D video footage from an ordinary or even cheap 3D camera system (e.g., on a conventional mobile phone). Alternatively, a single camera with sufficiently fast focus could be used to obtain the same images by switching focus quickly between the subject and background, or between any two or more objects at different focus distances, again depending on the speed of the auto focus component of the camera. In the embodiments described above involving scenes with four faces, the AF algorithm may be split across these four different face regions. The fast focus speed of an auto focus camera module that includes a MEMS actuator in accordance certain embodiments would be divided among the four face regions so as to slow the auto focus for each face region by a factor of four. However, if that reduction by four would still permit the auto focus to perform fast enough, a great advantage is achieved wherein video is optimized for each of multiple subjects in a scene.

In a video embodiment, the camera is configured to alternate focus between two or more subjects over a sequence of raw video frames. Prior to compression, the user may be asked (or there may be a predetermined default set for a face before starting to record) to select a face to prioritize or a face may be automatically selected based on predetermined criteria (size, time in tracking lock, recognition based on database of stored images and/or number of images stored that include certain identities, among other potential parameters that may be programmable or automatic. When compressing the video sequence, the compression algorithm may use a frame with focus priority on the selected face as a main frame or as a key frame in a GOP. Thus the compressed video will lose less detail on the selected “priority” face.

In another embodiment, techniques are used to capture video in low-light using sharp, underexposed video frames, combined with over-exposed video frames. These techniques are used in certain embodiments for adapting for facial focus. In such an embodiment, the first frame in a video sequence is one with a focus optimized for one of the subjects. Subsequent frames are generated by combining this frame with 2nd, 3rd, and 4th video frames (i.e., in the example of a scene with four face regions) to generate new 2nd, 3rd, 4th video frames which are “enhanced” by the 1st video frame to show the priority face with improved focus. This technique is particularly advantageous when large groups of people are included in a scene.

In a different context, such as capturing video sequences from the rides at a theme park or social gatherings or baseball or soccer games, or during the holidays, or in a team building exercise at the office, or other situation where a somewhat large group of people may be crowded into video sequences. The raw video sequences could be stored until a visitor is leaving the park, or goes to a booth, or logs into a website and uses a form of electronic payment or account, whereon the user can generate a compressed video that is optimized for a particular subject (chosen by the visitor). This offers advantageously improved quality which permits any of the multiple persons in the scene to be the star of the show, and can be tremendously valuable for capturing kids. Parents may be willing to pay for one or more or even several “optimized” videos (i.e., of the same raw video sequence), if there are demonstrable improvements in quality of each sequence at least regarding one different face in each sequence.

### Techniques Using Eye or Other Facial Sub-Region Information

Eye regions can be useful for accurate face focus, but as the eye is constantly changing state it is not always in an optimal (open) state for use as a focus region. In one embodiment a hardware template matching determines if an eye region is open and uses this as a focus region and the ISP applies a focus measure optimized for eye regions, and if the eye is not sufficiently open, then it defaults to a larger region such as the mouth or a half face or full face and uses a corresponding focus measure.

In a portrait mode embodiment, a camera module may use multiple focus areas on specific face regions, e.g., two or more of a single eye, an eye-region, an eye-nose region, a mouth, a hairline, a chin and a neck, and ears. In one embodiment, a single focus metric is determined that combines the focus measure for each of two or more specific facial sub-regions. A final portrait image may be acquired based on this single focus metric.

In an alternative embodiment, multiple images are acquired, each optimized to a single focus metric for a sub-region of the face (or combinations of two or more regions).

Each of the acquired frames is then verified for quality, typically by comparison with a reference image acquired with a standard face focus metric. Image frames that exceed a threshold variance from the reference are discarded, or re-acquired.

After discarding or re-acquiring some image frames a set of differently focused images remain and the facial regions are aligned and combined using a spatial weighting map. This map ensures that, for example, the image frame used to create the eye regions is strongly weighted in the vicinity of the eyes, but declines in the region of the nose and mouth. Intermediate areas of the face will be formed equally from multiple image frames which tend to provide a smoothing effect that may be similar to one or more of the beautification algorithms described at US published patent application no. 201010026833, which is incorporated by reference.

Techniques employed to generate HDR images and eliminate ghosting in such images, e.g., PCT/IB2012/000381, which is incorporated by reference, is advantageously combined with one or more of the fast auto focus MEMS-based camera module features described herein. The images utilized will include images with similar exposures, especially in portrait mode, while some of the exposure adjustment steps would be obviated in a portrait mode environment.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

A camera module in accordance with certain embodiments includes physical, electronic and optical architectures. Other camera module embodiments and embodiments of features and components of camera modules that may be included with alternative embodiments are described at U.S. patent application Ser. No. 13/913,356, which is incorporated by reference and is entitled MEMS Fast Focus Camera Module. U.S. Pat. Nos. 7,224,056, 7,683,468, 7,936,062, 7,935,568, 7,927,070, 7,858,445, 7,807,508, 7,569,424, 7,449,779, 7,443,597, 7,768,574, 7,593,636, 7,566,853, 8,005,268, 8,014,662, 8,090,252, 8,004,780, 8,119,516, 7,920,163, 7,747,155, 7,368,695, 7,095,054, 6,888,168, 6,583,444, and 5,882,221, and US published patent application nos. 2012/0063761, 201110317013, 201110255182, 201110274423, 201010053407, 2009/0212381, 2009/0023249, 2008/0296,717, 2008/0099907, 2008/0099900, 2008/0029879, 2007/0190747, 2007/0190691, 2007/0145564, 2007/0138644, 2007/0096312, 2007/0096311, 2007/0096295, 2005/0095835, 2005/0087861, 2005/0085016, 2005/0082654, 2005/0082653, 2005/0067688, and U.S. patent application No. 61/609,293, and PCT application nos. PCTlUS2012/024018 and PCT/IB2012/000381, which are all hereby incorporated by reference.

Components of MEMS actuators in accordance with alternative embodiments are described at U.S. Pat. Nos. 7,972,070, 8,014,662, 8,090,252, 8,004,780, 7,747,155, 7,990,628, 7,660,056, 7,869,701, 7,844,172, 7,832,948, 7,729,601, 7,787,198, 7,515,362, 7,697,831, 7,663,817, 7,769,284, 7,545,591, 7,792,421, 7,693,408, 7,697,834, 7,359,131, 7,785,023, 7,702,226, 7,769,281, 7,697,829, 7,560,679, 7,565,070, 7,570,882, 7,838,322, 7,359,130, 7,345,827, 7,813,634, 7,555,210, 7,646,969, 7,403,344, 7,495,852, 7,729,603, 7,477,400, 7,583,006, 7,477,842, 7,663,289, 7,266,272, 7,113,688, 7,640,803, 6,934,087, 6,850,675, 6,661,962, 6,738,177 and 6,516,109; and at

US Published Patent Application Nos. 20101030843, 2007/0052132, 201110317013, 2011/0255182, 2011/0274423, and at

U.S. patent application Ser. Nos. 13/442,721, 13/302,310, 131247,938, 131247,925, 131247,919, 13/247,906, 131247,902, 131247,898, 131247,895, 131247,888, 131247,869, 131247,847, 13/079,681, 13/008,254, 12/946,680, 12/946,670, 12/946,657, 12/946,646, 12/946,624, 12/946,614, 12/946,557, 12/946,543, 12/946,526, 12/946,515, 12/946,495, 12/946,466, 12/946,430, 12/946,396, 12/873,962, 12/848,804, 12/646,722, 121273,851, 25 121273,785, 111735,803, 111734,700, 111848,996, 111491,742, and at

PCT Application Nos. PCTIUSI2124018, PCTIUS11159446, PCTIUS11159437, PCTIUS11159435, PCTIUS11159427, PCTIUS11159420, PCTIUS11159415, PCTIUS11159414, PCTIUS11159403, PCTIUS11159387, PCTIUS11159385, PCTIUS10/36749, PCTIUS07/84343, and PCTlUS07/84301.

All references cited above and below herein are incorporated by reference, as well as the background, abstract and brief description of the drawings, and U.S. application Ser. Nos. 121213,472, 121225,591, 12/289,339, 121774,486, 131026,936, 13/026,937, 13/036,938, 13/027,175, 13/027,203, 13/027,219, 13/051,233, 13/1163,648, 13/264,251, and PCT application WO2007/110097, and U.S. Pat. No. 6,873,358, and RE42,898 are each incorporated by reference into the detailed description of the embodiments as disclosing alternative embodiments.

The following are also incorporated by reference as disclosing alternative embodiments:

U.S. Pat. Nos. 8,055,029, 7,855,737, 7,995,804, 7,970,182, 7,916,897, 8,081,254, 7,620,218, 7,995,855, 7,551,800, 7,515,740, 7,460,695, 7,965,875, 7,403,643, 7,916,971, 7,773,118, 8,055,067, 7,844,076, 7,315,631, 7,792,335, 7,680,342, 7,692,696, 7,599,577, 7,606,417, 7,747,596, 7,506,057, 7,685,341, 7,694,048, 7,715,597, 7,565,030, 7,636,486, 7,639,888, 7,536,036, 7,738,015, 7,590,305, 7,352,394, 7,564,994, 7,315,658, 7,630,006, 7,440,593, and 7,317,815, and

U.S. patent application Ser. Nos. 13/306,568, 13/282,458, 131234,149, 131234,146, 13/234,139, 131220,612, 13/084,340, 13/078,971, 13/077,936, 13/077,891, 13/035,907, 13/028,203, 13/020,805, 12/959,320, 12/944,701 and 12/944,662, and

United States published patent applications serial nos. 2012/0019614, 2012/0019613, 2012/0008002, 201110216156, 201110205381, 2012/0007942, 201110141227, 201110002506, 201110102553, 201010329582, 201110007174, 201010321537, 201110141226, 201010141787, 2011/0081052, 201010066822, 201010026831, 2009/0303343, 2009/0238419, 201010272363, 2009/0189998, 2009/0189997, 2009/0190803, 2009/0179999, 2009/0167893, 2009/0179998, 2008/0309769, 2008/0266419, 2008/0220750, 2008/0219517, 2009/0196466, 2009/0123063, 2008/0112599, 2009/0080713, 2009/0080797, 2009/0080796, 2008/0219581, 2009/0115915, 2008/0309770, 2007/0296833 and 2007/0269108.

CMOS Image Sensor Modifications: the following are incorporated by reference:
Chun, J.-B., Jung, H., & Kyung, C.-M. (2008). Suppressing rolling-shutter distortion of CMOS image sensors by motion vector detection. IEEE Transactions on Consumer Electronics, 54(4),1479-1487. doi:10.1109/TCE.2008.4711190
Huang, C., & Huang, J. (2012). A CMOS Active Pixel Sensor With Light Intensity Filtering Characteristics for Image Thresholding Application. Sensors Journal, Retrieved from http://ieeexplore.ieee.org/xpls/abs all.jsp?arnumber=6031894
Hynecek, 1. (2012). CMOS image sensor with complete pixel reset without kTC noise generation. EP Patent 1,235,277.
Kwon, O. (2012). CMOS IMAGE SENSOR WITH SHARED SENSING MODE. U.S. patent application Ser. No. 13/410,875.
Lee, W. (2012). CMOS image sensor with wide dynamic range. U.S. Pat. No. 8,188,524.
Vu, P., Fowler, B., & Liu, C. (2012). High-dynamic-range 4-Mpixel CMOS image sensor for scientific applications. IS&T/SPIE, Retrieved from http://proceedings.spiedigitallibrary.org/proceeding.asp x? articleid=1345580
Yeh, S., & Hsieh, C. (2012). A Dual-Exposure Single-Capture Wide Dynamic Range CMOS Image Sensor With Columnwise Highly/Lowly Illuminated Pixel Detection. Electron Devices, IEEE. Retrieved from http://ieeexplore.ieee.org/xpls/abs all.jsp?amumber=6192316 Provisional patent application no. 61/881,959 (FN-393P-US) by same Applicant entitled: Motion Determining & Compensating Techniques for MEMS Optical Image Stabilization (OIS)
System in a Handheld Imaging Device
Applicant: DigitalOptics Corporation Europe Limited
Inventors: Larry Murray, Pierre Bigeard, Petronel Bigioi & Peter Corcoran

What is claimed is:

1. A digital image acquisition apparatus, comprising:
an image acquisition sensor coupled to imaging optics for acquiring a sequence of images;
an image store for storing images acquired by said sensor;
an optical image stabilization sub-system to optically compensate for device motion during image acquisition up to a pre-determined motion threshold;
a motion detector for causing said sensor to cease capture of an image when a degree of movement in acquiring said image exceeds a threshold;
a controller for selectively transferring said image acquired by said sensor to said image store and resetting said image sensor and re-aligning the imaging optics with a main optical axis; and
an image merger for merging a selected plurality of images nominally of a same scene to produce a high quality image of said scene.

2. An apparatus as claimed in claim 1, wherein the motion detector determines an angular displacement of the imaging optics from the main optical axis and wherein capture of an image ceases when said displacement exceeds a pre-determined threshold.

3. An apparatus as claimed in claim 2, wherein said pre-determined threshold lies in a range of 0.5-1.0 degrees.

4. An apparatus as claimed in claim 3, wherein said optical image stabilization sub-system incorporates a 40 MEMS lens assembly.

5. An apparatus as claimed in claim 1, wherein said image store comprises a temporary image store, and wherein said apparatus further comprises a non-volatile memory, said image merger being configured to store said high quality image in said non-volatile memory.

6. An apparatus as claimed in claim 1, wherein said motion detector comprises a gyrosensor or an accelerometer, or both.

7. A digital image acquisition apparatus, comprising:
an image acquisition sensor coupled to imaging optics for acquiring a sequence of images;
an image store for storing images acquired by said sensor;
a motion detector for causing said sensor to cease capture of an image when a degree of movement in acquiring said image exceeds a first threshold;
one or more controllers that causes the sensor to restart capture when the degree of movement is less than a given second threshold and that selectively transfers said image acquired by said sensor to said image store;
a motion extractor for determining motion parameters of a selected image stored in said image store;
an image re-constructor for correcting a selected image with associated motion parameters; and
an image merger for merging a selected plurality of images nominally of the same scene and corrected by said image re-constructor to produce a high quality image of said scene.

8. An apparatus as claimed in claim 7, further comprising a first exposure timer for storing an aggregate exposure time of a sequence of images, and wherein said apparatus is configured to acquire said sequence of images until the aggregate exposure time of at least a stored number of said sequence of images exceeds a predetermined exposure time for said high quality image.

9. An apparatus as claimed in claim 8, further comprising a second timer for storing an exposure time for a single image, and wherein said apparatus is configured to dispose of an image having an exposure time less than a threshold time.

10. An apparatus as claimed in claim 8, further comprising an image quality analyzer for a single image, and wherein said apparatus is configured to dispose of an image having a quality less than a given threshold quality.

11. An apparatus as claimed in claim 7, wherein said image merger is configured to align said selected plurality of images prior to merging said images.

12. An apparatus as claimed in claim 7, wherein said first and second thresholds comprise threshold amounts of motion energy.

13. An auto focus camera module, comprising:
a camera module housing defining an aperture and an internal cavity to accommodate camera module components;
an image sensor coupled to or within the housing;
a lens barrel within the housing that contains an optical train including at least one movable lens disposed relative to the aperture and image sensor to focus images of scenes onto the image sensor along an optical path; and
a fast focus MEMS actuator coupled to one or more lenses of the optical train including the at least one movable lens and configured to rapidly move said at least one movable lens relative to the image sensor to provide autofocus for the camera module in each frame of a preview or video sequence or both.

14. The camera module of claim 13, wherein the fast focus MEMS actuator is configured to reliably refocus within approximately 33 ms.

15. The camera module of claim 13, comprising a face tracking module that is configured to predict a location of a face region of interest in a future frame permitting the auto focus camera module to focus on the region of interest quickly.

16. The camera module of claim 13, comprising a face detection module that is configured to apply multiple short classifier chains in parallel to one or more windows of an image frame.

17. The camera module of claim 13, wherein the actuator is configured to alternately auto focus on two or more regions of interest, such that each region of interest is refocused every respective two or more frames of the preview or video sequence or both.

18. The camera module of claim 13, wherein the two or more regions of interest comprise two or more sub-regions of a face.

19. The camera module of claim 13, comprising a face recognition module that is configured to identify and prioritize one or more faces that correspond to one or more specific persons.
